(19) United States
(12) Patent Application Publication
(10) Pub. No.: US 2005/0075918 A1
(43) Pub. Date: Apr. 7, 2005

(54) Work management system

(75) Inventor: Noriyuki Yanagimachi, Matsudo-shi (JP)

Correspondence Address: MUSERLIAN, LUCAS AND MERCANTI, LLP, 475 PARK AVENUE SOUTH, 15TH FLOOR, NEW YORK, NY, 10016, US

(73) Assignee: Konica Minolta Medical & Graphic, Inc., Tokyo (JP)

(21) Appl. No.: 10/897,725

(22) Filed: Jul. 23, 2004

(30) Foreign Application Priority Data
Aug. 6, 2003 (JP) JP2003-288216

(51) Int. Cl. G06F 17/60

(52) U.S. Cl. 705/8; 705/9

(57) ABSTRACT

In a work management system to manage working conditions through a network, when a work start order is inputted by a worker at the working terminal in accordance with the action set by the work setter and the file server connects the working terminal and a job directory to store a job of the action, the file server produces a verification file to record the attribute of the job directory for the worker, and when the worker inputs a work cancel order, the file server produces a comparison file to record the attribute of the job directory for the worker and judges a justification of the work cancel order on a basis of an identity between the attribute of the job directory recorded in the verification file and the attribute of the job directory recorded in the comparison file.

### BACKGROUND OF THE INVENTION

The present invention relates to a work management system, and particularly relates to a work management system having a high degree of freedom in changing a work state by accepting a request for cancellation of work.

Conventionally, when a request has been made in a printing company to workers, for example, a request for adjusting colors (hereinafter, referred to as a color adjustment work) in an image on a spring brochure, which is an ordered item, it is extremely vague how much time the color adjustment work has taken the workers who have received the request, because the only available information is working hours recorded by the individual workers having received the request.

In another point of view, as networking such as an internal LAN has been promoted in recent years, also requests to others for a color adjustment work have come to be made via networks including internal LANs.

FIG. 14 shows a data access method in a conventional internal LAN. In FIG. 14, numeral 100 denotes a shared hard disk area having been set in advance in a manner allowing a plurality of clients 200a, 200b, and 200c to share the area. Such sharing setting is usually performed at the time of setting an internal LAN or the like, and after the setting, any of the clients 200a, 200b, and 200c can access the shared area. Therefore, when a client 200a requests another client 200b for a color adjustment work, the client 200a stores a file related to the color adjustment work in the shared hard disk area 100, then the other client 200b accesses the shared hard disk area 100, thereby accessing the file related to the color adjustment work to perform the color adjustment work.

This method allows a color adjustment work via a network, giving advantages in speedup and efficiency of work.

In the network with such an internal LAN configuration, the shared hard disk area 100 is set in advance at the time of setting the network, and access by the clients 200a, 200b, or 200c to the file related to the color adjustment work is implemented through access to the shared hard disk area 100, which makes it impossible at all to know which client is accessing to which file.

Further, a person who has made a request for a color adjustment work cannot know the progress of the color adjustment work by the request on the way, an thus, nor can the person, who has made the request for a color adjustment work, manage the color adjustment work by his/her own request.

In this situation, the inventors offered a work management system disclosed in Patent Document 1. In this work management system, a product to be accomplished through a series of works is defined as a job, wherein the system permits only users, the users having been set as workers in a job directory in which a file related to the job is stored, to have a logical direct connection with the job directory. This invention permits only workers, the workers having been set in advance for the job, to work on the job, thus enabling easy management of the progress state of works being set in the job.

In this work management system, a work group may be constituted by a plurality of workers, and management of work performed by this group can be managed.

[Patent Document 1] TOKKAI No. 2002-328826

[Problem to be solved]

The inventors made efforts to further improve the above system, and found another problem in the work management of individual workers in a group work.

For example, in the case that a worker had altered data in a job directory through work, and thereafter, another worker has directly accessed the same job directory without working, the following problem was found. That is, as to whether or not said another worker has worked on the directory is determined according to whether or not the data, the data being in the job directory which said another worker has directly accessed, has been altered. Consequently, in this case, said another worker described above having accessed the job directory after the data had been altered is, in management, determined to have worked, even though he actually did not. Therefore, it may be considered that, by accepting declaration, of cancellation of work, by a worker having once declared working-start, a worker who has not worked should be deleted from the object of management. However, if cancellation of work is accepted without judging whether or not such a declaration of cancellation of work is justified, the worker is, in management, determined not to have worked, even if the worker has actually worked.

The inventors further discussed to solve this problem, introduced a concept of creating a verification file to compare with a comparison file, discussed from various aspects on the timing of creating the two files and the timing of comparing and verifying the files, and thus achieved the invention.

The logic of cancellation of work of the invention can be applied even in the case of a single worker.

### SUMMARY OF THE INVENTION

Therefore, an object of the invention is to provide a work management system that allows an accurate work management in which workers who have worked can be verified by preventing unjust cancellations of work by other workers.

Another object of the invention is to provide, even for the case of group working, a work management system that allows work management of individual workers who are members of a work group.

Other objects of the invention will become apparent by the following description.

The above problem will be solved by each of the following items.
(1) A work management system that determines whether or not a command issued to cancel work is justified, as described below. The work management system is provided with work terminals used by workers, work setting terminals used by work setters, file servers that record a job directory in which a single or more files related to a job are stored, and a database server for recording management information for managing work. When work for a job and workers who can carry out the work are set via a work setting terminal as an action, the work setting terminal requests the database server to set the action, and then the database server records the setting of the action as management information upon the request. When a command to start work with designation of an action is issued via the work terminal, the work terminal requests a file server for direct connection, then the file server inquires the database server to confirm whether this request is justified. If the request is justified, the file server makes the job directory, in which the job of the action related to this request is stored, into a connectable state to permit the work terminal to make the connection. The work terminal, having been permitted, directly connects the work directory on the work terminal and the job directory, and then the database server records the fact that work has started, as management information, on the action, of the individual worker who uses the work terminal. On the other hand, when a command to cancel work with designation of the action is issued via the work terminal, the work terminal requests the file server for cancellation of work, then the file server inquiries the database server to confirm whether this request is justified. If the request is justified, and the work directory on the work terminal and the job directory on the file server, the file server in which the job of the action related to the request is stored, are in a state of direct connection, then the work terminal cuts off the direct connection between the work-directory on the work terminal and the job directory on the server, the server in which the job of the action related to the request is stored, and the database server deletes the management information, on the action, of the individual worker who uses the work terminal. If the request is justified, and the work directory on the work terminal and the job directory on the file server are not in a state of connection, then the database server deletes the management information, on the action, of the individual worker who uses the work terminal. In this situation, a work management system of a first aspect of the invention will be described below. When the work terminal of the worker directly connects the work directory and the job directory, the job directory in which the job of the action is stored, for the first time upon the command to start work, the file server creates, for the individual worker, a verification file that records the file attributes of the file in the job directory to be the object of the direct connection. When the file server receives a command to cancel work on the action, the file server creates a comparison file that records the file attributes of the file in the job directory on the file server in which the job of the action related to the command is stored, and determines whether the cancellation of work is justified, according to substantial identity between the information recorded in the verification file and the information recorded in the comparison file.
(2) The work management system according to item (1), wherein, upon a command to suspend work with designation of an action via the work terminal, the work terminal cuts off the direct connection between the work directory on the work terminal and the job directory on the file server in which the job of the action related to the command is stored, and the database server records that the work is suspended.
(3) The work management system according to item (1) or (2), wherein the managed work includes group work.
(4) The work management system according to any one of items 1 to 3, wherein the file attributes recorded in the verification file and the comparison file do not include file attributes of files that the operation system has automatically created.
(5) The work management system according to any one of items 1 to 4, wherein the file attributes recorded in the verification file and the comparison file include at least one of a path name, a file name, a file size, an updated date-and-time, and a file type.
(6) The work management system according to any one of items 1 to 5, wherein, when the file server determines that a command to cancel work is justified, the file server deletes a verification file and a comparison file related to the command to cancel work.

### BRIEF DESCRIPTION OF THE DRAWINGS

FIG. 1 is a diagram showing a preferable embodiment of a work management system of the invention;

FIG. 2 is a diagram showing an example of management information recorded in a database server 50 to manage work in the work management system of the invention;

FIG. 3 is a diagram showing an example of management information recorded in the database server 50 to manage work in the work management system of the invention;

FIG. 4 is a diagram showing an example of management information recorded in the database server 50 to manage work in the work management system of the invention;

FIG. 5 is a diagram showing an example of management information recorded in the database server 50 to manage work in the work management system of the invention;

FIG. 6 is a diagram showing an example of management information recorded in the database server 50 to manage work in the work management system of the invention;

FIG. 7 is a diagram showing an example of management information recorded in the database server 50 to manage work in the work management system of the invention;

FIG. 8 is a diagram showing an example of management information recorded in the database server 50 to manage work in the work management system of the invention;

FIG. 9 is a diagram explaining the relationship between action states and the respective action operator states;

FIG. 10 is a diagram showing an example of the contents of a verification file and a comparison file;

FIGS. 11a and 11b are diagrams showing an example of the relationship between job directories, verification files, and comparison files, wherein FIG. 11a shows an example of the directory structure of a job directory, while FIG. 11b shows examples of a verification file and a comparison file that record a file set of the job directory;

FIG. 12 is a flowchart showing verification processing in the case of issuing a command to start work in the system shown in FIG. 1;

FIG. 13 is a flowchart showing verification processing in the case of issuing a command to cancel work in the system shown in FIG. 1; and

FIG. 14 is a diagram showing an example of a data access method in a conventional internal LAN.

### DETAILED DESCRIPTION OF THE PREFERRED EMBODIMENT

An embodiment of the invention will be described below in detail.

A work management system of the invention can be preferably applied to the case where work is performed, accessing data in a computer environment in which computers are connected by a network. For example, the invention is preferably applicable in the filed of printing including DTP and prepress, in the medical industry, where X-ray images are managed and operated, and in the photographic and image processing industry including online publishing, electronic publishing, and postcard publishing.

Next, a work management system according to the invention will be described in detail.

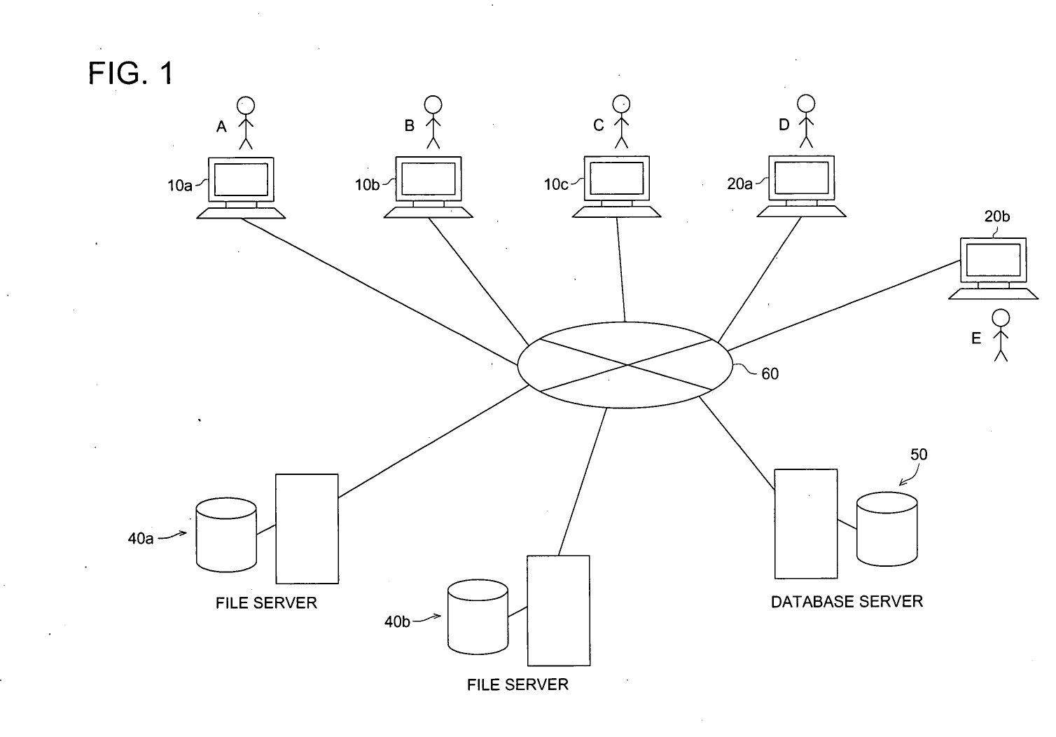

FIG. 1 is a diagram showing a preferable embodiment of a work management system of the invention.

Before explaining the configuration forming the characteristics of the work management system of the invention, first, prerequisite configuration will be described.

In FIG. 1, numerals 10a, 10b, and 10c denote respective work terminals used by workers A, B, and C, while numerals 20a and 20b denote respective work setting terminals used by work setters D and E who set work.

Numerals 40a and 40b denote file servers which record a single or more job directories that store files related to jobs. The job directories store files related to a job and are arranged for the respective jobs.

Numeral 50 denotes a database server which records management information.

In the work management system of the invention, when a user who inputs via a respective work terminal or work setting terminal (hereinafter, these terminals are also referred to as terminal devices) is identified respectively as worker A, B, or C, or work setter D or E, then the user can work as worker A, B, or C, or set work as work setter C or E. This identification by the work management system of the invention can be achieved by methods, including a method in which a user ID and a password corresponding to the respective worker A, B, or C, or the respective work setter D or E are issued, and a user is allowed to use the work management system of the invention at the respective terminal only when inputs of the user ID and the password accord.

Further, it is possible, via the work setting terminals 20a and 20b, to set a work (for example, “color adjustment”) for a job (for example, “a spring brochure”) and a worker (for example, “Yamada”) who can perform the work, as an action. More than a single person may be set in this action, and also, a work group of a plurality of workers may be set.

A job is defined by a product to be accomplished through a series of works. For example, to finish a spring brochure which is an ordered item handled by a printing company, a series of works is performed, including image adjustment, color adjustment, and document correction, wherein the concept for handling the ordered item to be the object of the series of works on the system is a job.

When a user who inputs via the work terminals 10a, 10b, or 10c is respectively identified by the work management system of the invention as the worker A, B, or C, a work directory corresponding to the respective worker A, B, or C is provided on the respective work terminal 10a, 10b, or 10c. A work directory is a directory which is set accessibly for the respective corresponding worker, wherein a worker can work for the action of a job stored in a job directory having been directly connected, by accessing a file server via the work directory. When a work group instead of workers is set as an action, anyone of a plurality of workers who are members of this work group can work on the action having been set.

A worker issues a command to change a work state via the respective work terminal 10a, 10b, or 10c, and thereby decide the worker's own work state. A command to change a work state, as described above, can be a command to start work, or a command to cancel work, or also can be a command to suspend work or a command to terminate work.

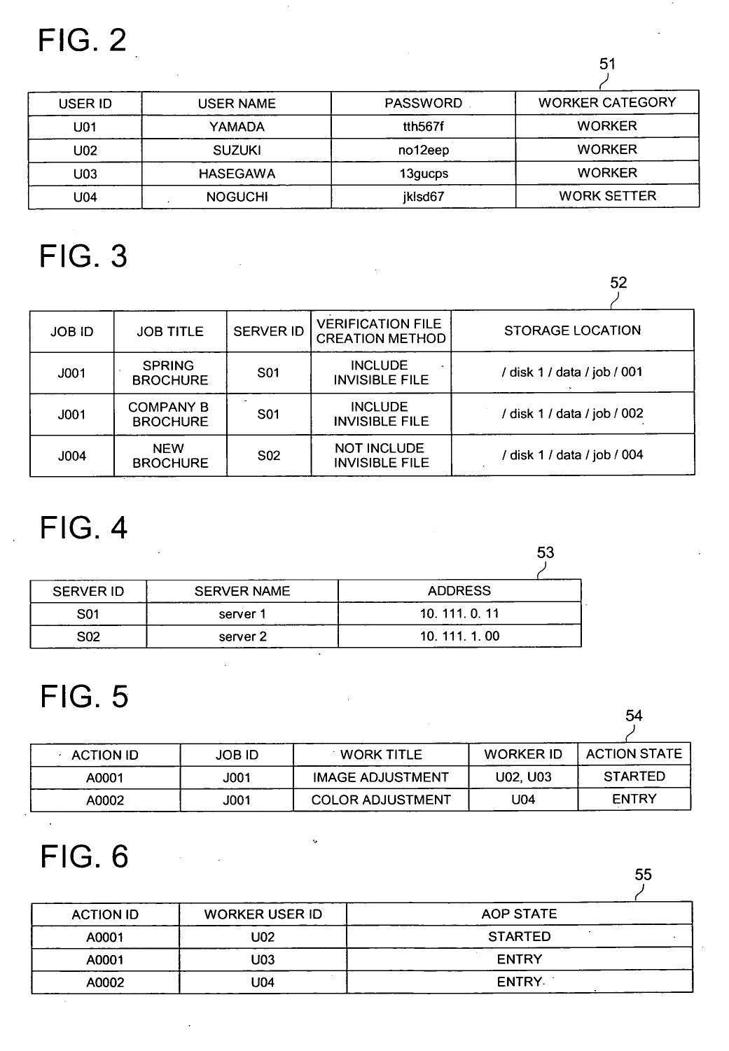

FIGS. 2 to 8 show examples of management information recorded in the database server 50 to manage work in the work management system of the invention. FIGS. 2 to 8 show the recorded management information as tables, as examples.

FIG. 2 shows user information table 51 which is used to identify users who use a work terminal or a work setting terminal. In the user information table 51, records are recorded for individual users, each record having each field information of, for example, “user ID” to identify a user, “user name” indicating the name of a user, “password” to authenticate a user, and a “worker category” to distinguish workers and work setters. A user having been recorded as a worker in the worker category filed is recognized to be a worker, and a user having been recorded as a work setter in the worker category filed is recognized to be a work setter.

FIG. 3 shows job information table 52 which is used to record information on jobs, such as storage locations of jobs and job titles. In the job information table 52, records are recorded for individual jobs, each record having each field information of, for example, “job ID” to identify a job, “job title” indicating the title of the job, “server ID” to identify a file server in which the job directory being the storage location of the job is recorded, “verification file creating method” that indicates whether or not the file attributes of invisible files are included in file attributes which are recorded in a later described verification file and comparison file, and “storage location” to indicate the storage location of the job directory in the file server. Each record in this job information table 52 is recorded when a job is registered in the present system.

FIG. 4 shows server information table 53 to be used for management of servers in which job directories, as mentioned above, are recorded. In the job information table 53, records are recorded for individual servers, each record having each field information of, for example, “server ID” to identify a server, “server name” indicating the name of the server, and “address” indicating the address of the server on the network.

FIG. 5 shows action information table 54 to be used for management of the content and state of each action. In the action information table 54, records are recorded for individual actions, each record having each field information of, for example, “action ID” to identify an action, “job ID” to identify a job, “work title” indicating the title of work, “worker user ID” indicating a user ID or IDs of users being set as workers, and “action status” indicating the state of the action. Each record on the action information table 54 is newly recorded when an action is set via the work setting terminal 20a or 20b. On a record of an action having been recorded once, field information is properly updated when a command to change a work state, described later, is received at the work terminal 10a, 10b, or 10c.

FIG. 6 shows action operator information table 55 to be used for management of action operator states (also referred to as AOP states) which are states of individual workers in respective actions. In the action operator information table 55, records are recorded for the individual actions, each record having each field information of, for example, “action ID” to identify an action, “worker user ID” which is the user ID of a worker, and “AOP state” indicating the state of work of the worker in the action. When a command to change a work state, described later, is received at the work terminal 10a, 10b, or 10c, field information is properly updated on a corresponding respective record of the action operator information table 55, or a new record is recorded, or a record is deleted.

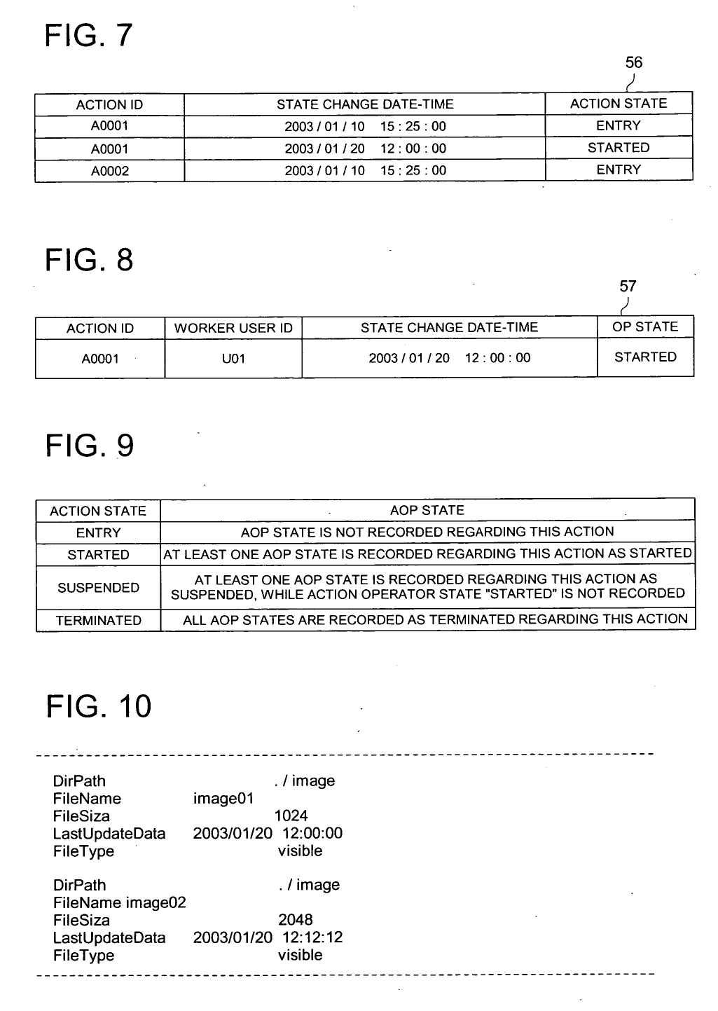

FIG. 7 is action state transition table 56 to be used for management of the history of changes of action state. In the action state transition table 56, a record is recorded each time an action state is changed, each record having each field information of, for example, “action ID” to identify the action, “state change date-and-time” indicating the date-and-time when the action state was changed, and “action state” being the work state of the action.

FIG. 8 is action operator state transition table 57 to be used for management of the history of changes of operator state. On the action operator state transition table 57, a record is provided each time an action operator state is changed, each record having each field information of, for example, “action ID” to identify an action, “worker user ID” being a worker's user ID, “state change date-and-time” indicating the date-and-time when the AOP state was changed, and “AOP state” indicating the work state of the worker on the action. Work time of each worker and work time of each action can be calculated, according to this history, which enables management of work.

In the work management system of the invention, as shown in FIGS. 5 to 7, management of work on actions is performed with an index of an action state which is the work state on the action. This action state takes values of, for example, “entry” indicating the state that the action has been set, but work has not yet started, “started” indicating the state that work has started on the action by the worker, “suspended” indicating the state that a work having started once on the action by the worker is currently suspended, and “terminated” indicating the state that work on the action has been terminated by the worker.

In the work management system, as shown in FIGS. 6 to 8, management of work of individual workers on the respective actions is performed with an index of an action operator state which is the work state of the individual workers on the respective actions. The action operator state takes values of, for example, “started” indicating the state that work has started on the action by the worker, “suspended” indicating the state that a work having started once on the action by the worker is currently suspended, and “terminated” indicating the state that work on the action has been terminated by the worker.

In the case where a single worker works on an action, the action state becomes the same as the action operator state of the worker, while in the case where a plurality of workers are set on an action, decision is made based on the total of action operator states of the plurality of workers. FIG. 9 is a diagram explaining the relationship between the action states and the action operator states.

As shown in FIG. 9, if the action operator state related to an action is not yet recorded on the action operator information table 55, the action state is “entry”. If at least one action operator state related to this action is recorded “start”, the action state is recorded as “started”. Further, if at least one action operator state related to the action is recorded “suspended” and there is no action operator state recorded as “started”, the action state is recorded as “suspended”. If all the action operator states related to the action are recorded “terminated”, the action state is recorded as “terminated”.

The action operator state is changed via the work terminal 10a, 10b, or 10c, according to a command to change a work state, with designation of action.

First, a description will be given on the case when a command to start work is issued with designation of an action, via the work terminal 10a, 10b, or 10c.

The work terminal 10a, 10b, or 10c having received the input for starting work requests the file server 40a or 40b for direct connection.

The file server 40a or 40b inquires the database server 50 to confirm whether the request is justified. If the request is justified, then the file server 40a or 40b makes the job directory, in which the job of the action is stored, connectable, and thus permits the work terminals to connect with the job directory.

The work terminal 10a, 10b, or 10c, having been permitted for connection, directly connects the work directory thereon with the job directory, and the database server 50 records the fact the work is started as management information, on the action, of the individual worker who uses the work terminal 10a, 10b, or 10c. Specifically, regarding recording for the management information, for example, a record is newly recorded in the action operator information table 55, as shown in FIG. 6, the record having field information including ID of the action, the worker user ID of the worker having input the command via the work terminals 10a, 10b, or 10c, and the action operator state of a value “start”. A record is newly recorded also on the action operator state transition information table 57, as shown in FIG. 8, the record having field information including ID of the action, worker user ID of the worker having input the command via the work terminal 10a, 10b, or 10c, the data-and-time when the change of work was performed, and the action operator state of a value “start”.

The direct connection by the work terminal, and recording as management information by the database server, may be performed in parallel. The management information to be recorded-by the database server 50 may be directly transmitted from the work terminal 10a, 10b, or 10c, or may be transmitted via the file server 40a or 40b. In the processing flow described later, an embodiment in which information is transmitted through the file server 40a or 40b is described, as an example.

Next, the case where a command to suspend work with designation of an action is performed via the work terminals 10a, 10b, or 10c will be described.

The work terminal 10a, 10b, or 10c having received the input for suspending work cuts off the direct connection between the work directory on the work terminal and the job directory, and the database server 50 records the suspension of work as management information, on the action, of the individual worker who uses the work terminal 10a, 10b, or 10c. Specifically, regarding recording for the management information, on the action operator information table 55, specifically, for example, the filed information of the action operator state in the record, the record corresponding to the action and the worker, is changed to “suspended”. On the action operator state transition table 57, as shown in FIG. 8, a record is newly recorded, the record having field information including ID of the action, the worker user ID of the worker having input the command via the work terminals 10a, 10b, or 10c, the date-and-time when work was changed, and the action operator state of a value “suspended”.

Cutting off the direct connection by the work terminal 10a, 10b, or 10c, and the recording of the management information by the database server 50 may be performed in parallel. The management information to be recorded by the database server 50 may be transmitted directly from the work terminal 10a, 10b, or 10c, and may be transmitted via the file server 40a or 40b. In the processing flow later described, an embodiment in which the information is transmitted via a file server is described as an example.

When a command to terminate work with designation of an action is input via the work terminal 10a, 10b, or 10c, the processing flow is basically the same as in the case of a work suspension except that the action operator state is recorded as “terminated” instead of “suspended”.

The case where a command to cancel work with designation of an action is input via the work terminal 10a, 10b, or 10c will be described below.

The work terminal 10a, 10c, or 10c having received the command to cancel work requests the file server 40a or 40b for cancellation of work.

The file server 40a or 40b inquiries the database server 50 to confirm whether the request is justified. If the request is justified, and if the work directory on the work terminal, and the job directory on the file server 40a or 40b in which the job of the action related to the request is stored, are in a direct connection state, the work terminal 10a, 10b, or 10c cuts off the direct connection between the work directory on the work terminal 10a, 10b, or 10c, and the job directory on the fie server 40a or 40b in which the job of the action related to the request is stored, and further, the database server 50 deletes the management information, related to the action, of the individual worker who uses the work terminal 10a, 10b, or 10c.

If the request is justified, and the work directory and the job directory are not in a state of direct connection, the database server 50 deletes management information, related to the action, of the individual worker who uses a work terminal.

Cutting off the direct connection by the work terminal 10a, 10b, or 10c, and the deletion of the management information by the database server 50 may be performed in parallel. The command to delete the management information by the database server 50 may be given directly from the work terminal 10a, 10b, or 10c, or may be given via the file server 40a or 40b. In the processing flow described later, an embodiment in which the command to delete the management information is given via the file server 40a or 40b is described as an example.

The deletion of the management information is, specifically, deletion of a record corresponding to the action and the worker recorded in the action operator information table 55, as shown in FIG. 6 for example, and deletion of a record corresponding to the action and the worker in the action operator state transition table, as shown in FIG. 8 for example.

When the direct connection between the work directory of the work terminal 10a, 10b, or 10c and the job directory is permitted, the job directory is preferably controlled by the file server 40a or 40b in the following manner. The job directory is set in advance in a state prohibiting direct connection (hereinafter, also referred to as access), and when a change for direct connection is requested based on a request for a change of a work state, the file server 40a or 40b inquiries the database server 50 whether the request for the change of the work state is justified, and after the request is determined to be justified, the file server 40a or 40b sets the job directory in a state allowing direct connection, thus the file server 40a or 40b controlling direct connection.

As the method for controlling such direct connection, the following methods or the like can be employed. 1) A method that divides the recording areas of the file server 40a and 40b into a direct connection permitting area which permits direct connection and into a direct connection prohibiting area which prohibits direct connection, and moves a job directory between the direct connection permitting area and the direct connection prohibiting area, if necessary. 2) A method that provides a hard link in a direct connection permitting area to control direct connection to the job directory. 3) A method that controls a job directory recorded in the file server 40a or 40b to a setting that permits direct connection or a setting that prohibits direct. connection, thereby controlling access.

In the invention, a hard link means setting a link (entrance to connection) to data that is present already without recording data itself in a directory.

Preparation processing of the work management system of the invention has been described above.

Next, verification processing, which is a characteristic of the work management system of the invention, will be described.

In the verification processing, which is a characteristic of the invention, verification file and a comparison file are properly created by the file server 40a or 40b, thereby it is determined whether cancellation of work is justified, according as to whether information recorded in the verification file and information recorded in the comparison file are substantially identical, and thus the cancellation of work is permitted.

Substantial identity means that, for example, when both the files are created in the same format, information, to be a comparison object, of both the files accord with each other without being more or less than each other.

A verification file and comparison file can be created by being given information as shown in FIG. 10, for example. The created verification file is recorded in the file server 40a or 40b. FIG. 10 is a diagram showing an example of the content of the verification file and the comparison file, wherein, from the top, a path name, a file name, a file size, a update date, and a file type are recorded in the verification file and the comparison file, as attributes of files in a job directory to be an object. FIG. 10 shows an example of a verification file and a comparison file in the case where 2 files are present in a directory. The file attributes recorded in the verification file and the comparison file preferably do not include file attributes automatically created by the operation system.

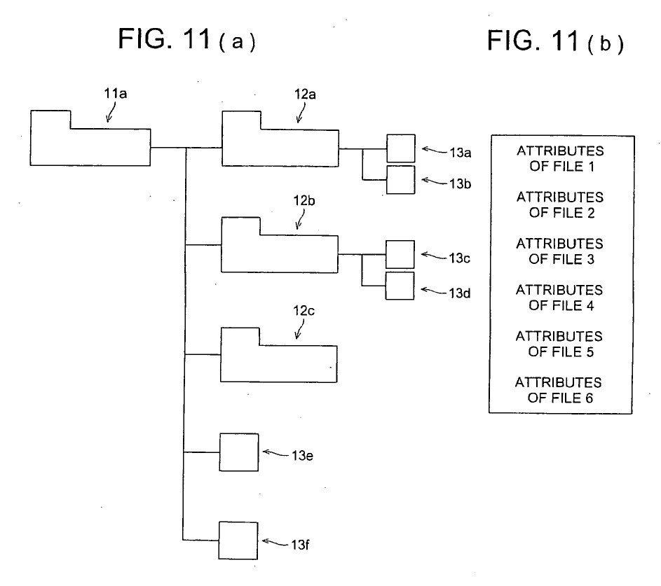

FIGS. 11a and 11b are diagrams showing the relationship between a job directory, a verification file, and a comparison file, wherein FIG. 11a shows an example of the directory structure of a job directory, while FIG. 11b shows examples of a verification file and a comparison file that record a file set of the job directory. The job directory 11a stores subdirectories 12a, 12b, and 12c, and files 13e and 13f. The sub directory 12a stores files 13a and 13b, while the subdirectory 12b stores files 13c and 13d. A verification file and a comparison file which record file attributes of the job directory 11a are created in such a manner that the verification file and the comparison file respectively record the file attributes of the files 13a to 13f.

A verification file and a comparison file in the invention may be information that is temporarily recorded on a memory, and are not necessarily required to be in a file format.

In the work management system of the invention, when a worker has issued, for the first time, a command to start work on an action, specifically, when action information of the individual worker has been registered in the table 55 in FIG. 6, a verification file is created by the file server 40a or 40b, for the individual worker. The verification file having been created is stored until a comparison file is created so as to determine the substantial identity with the comparison file for the individual worker. On the other hand, a comparison file is created when verification is performed. In the invention, when a command to cancel work is received, specifically, by the work terminal 10a, 10b, or 10c, verification is performed by the file server 40a or 40b. In a preferable embodiment, when a command to cancel work or a command to terminate work is determined to be justified, a verification file and a comparison file related to the command are deleted.

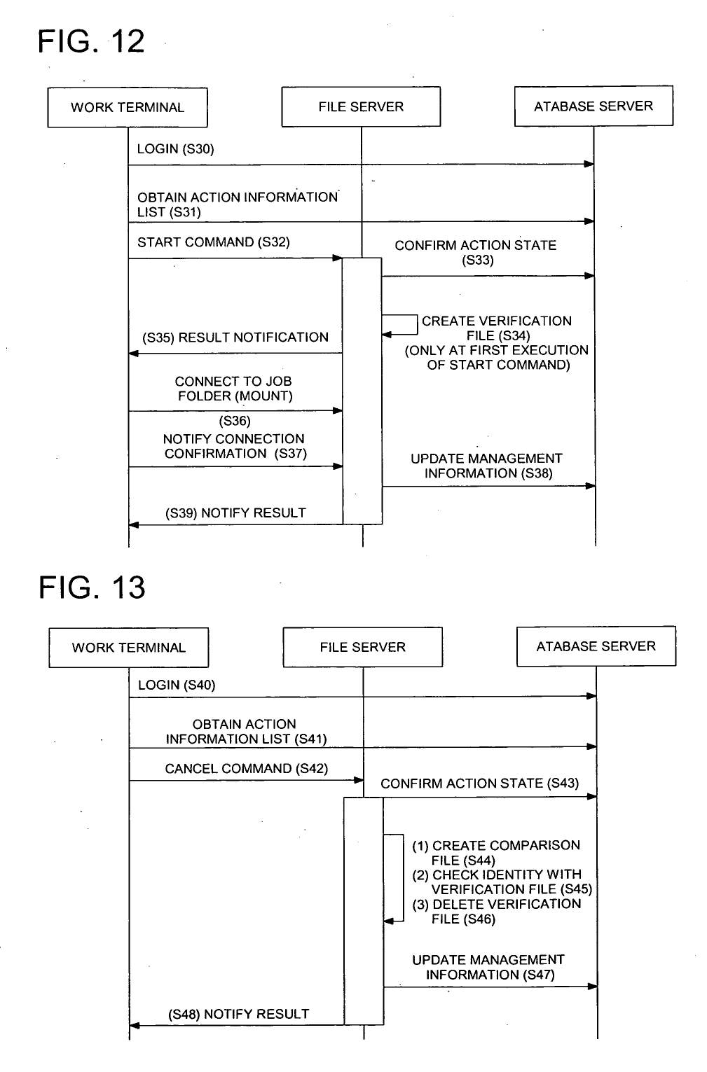

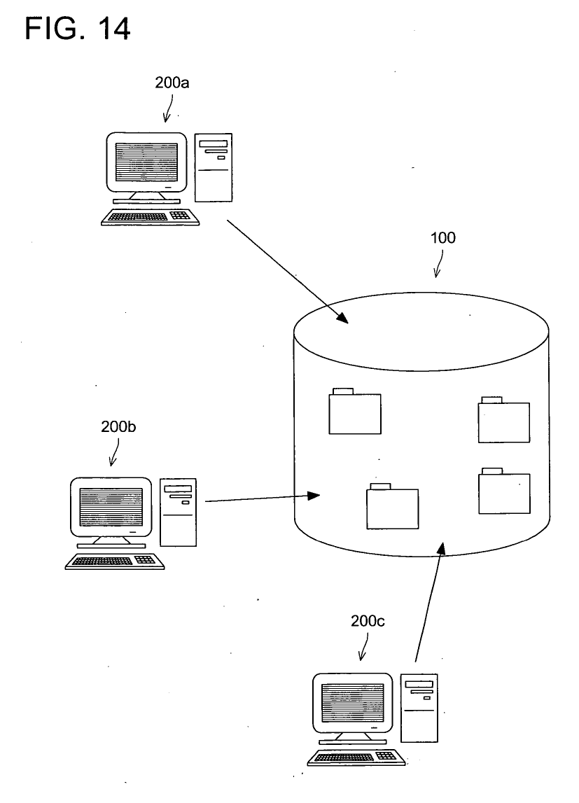

FIG. 12 is a flowchart showing the verification process in the case of issuing a command to start work on the system in FIG. 1, while FIG. 13 is a flowchart showing the verification process in the case of issuing a command to cancel work on the system in FIG. 1.

In FIG. 12, the work terminal 10a requests the database server 50 for logging in (S30), and obtains a list of action information in which the worker having logged in is recorded (S31).

The worker selects an action on which to start work, from the obtained action information and sends the file server 40b a command to start work from the work terminal (S32). In this situation, the job directory of the action related to the command to start work is stored in the file server 40b. The file server 40b, having received the command to start work, inquires the database server 50 to confirm the action state, and determines whether to permit the command to start work (S33). In the case where the file server 40b permits the command to start work on the action of the worker for the first time, the file server 40b creates a verification file for the individual worker and records the verification file (S34), and the result of permitting the command to start work is notified to the work terminal 10a (S35).

The work terminal 10a, having received the notification, mounts on the job directory (that is, direct connection between the work directory and the job directory) (S36), and notifies the file server 40b to confirm whether the connection has been made (S37).

The file server 40b requests the database server 50 to update the management information (S38), and notifies the updated result to the work terminal 10a (S39).

Thereafter, when a command to cancel work is received via the work terminal 10a, processing, as shown in FIG. 13, is performed.

In FIG. 13, the terminal 10a requests the database server 50 for logging in with designation of a worker (S40), and obtains a list of action information, in which the worker having logged in is recorded (S41).

The action on which to cancel work is selected from the obtained action information, and a command to cancel work is issued via the work terminal 10a to the file server 40b (S42).

The file server 40b, having received the command to cancel work, inquires the database server 50 to confirm the action state (S43). If the action state is in a status allowing cancellation of work, then the file server 40b creates a comparison file (S44), and determines substantial identity with the verification file (S45). If the substantial identity is confirmed, then the file server 40b deletes the comparison file (S46) . Thereafter, the file server 40b requests the database server 50 to update the management information (S47), and notifies the work terminal 10a of the result that the command to cancel work has been accepted (S48).

At above timings, a verification file is created and verification is performed. In performing work management of a group work at these timings, unjust cancellation of work by a worker can be prohibited, and thus a worker in the work group is little affected by another worker in the work group.

Incidentally, the work management system can be preferably applied to the case where work is performed on an action for which a group consisting of a plurality of workers is set as workers on the action. The reason for this will be described below.

As an example, the case where there is a job directory H in which a file related to a job is stored will be discussed below, wherein an action C with a work group consisting of a worker A and a worker B is set for the Job.

When the worker A issues a command to start work on the action C, a verification file D is created based on the job directory H.

When the worker A works on the action C, the job directory H is given a change and turns into a job directory H′. After the job directory H turns into the job directory H′, when the worker B issues a command to start work, designating the action C, a verification file E is created for the worker B based on the changed job directory H′.

Thereafter, when the worker B issues a command to cancel work without working on the action C, in other words, without giving a change to the job directory H′, then a comparison file F is created based on the job directory H′, and the justice of the cancellation of work is determined based on substantial identity between the verification file E and the comparison file F. In this situation, since the verification file E and the comparison file F are created based on the same job directory H′, the verification file E and the comparison file F are substantially identical, by which the cancellation of work by the worker B is determined to be justified.

If the worker A issues a command to cancel work, then a comparison file G is created based on the job directory H′, and justice of the cancellation of work is determined based on substantial identity between the verification file D and the comparison file G. In this situation, although the verification file D is created based on the job directory H, the comparison file G is created based on the job directory H′. Accordingly, the verification file D and the comparison file G are substantially nonidentical, and thus the cancellation of work by the worker A is determined to be unjust.

As described above, in the group work, the worker B having not worked can cancel work without being affected by the worker A. On the other hand, the cancellation of work by the worker A having worked cannot be accepted, and thereby an unjust cancellation of work can be prevented. Therefore, the work management system can be preferably applied to a group work.

1. A work management system to manage working conditions through a network, comprising:
a work setting terminal at which a work setter sets an action to designate a name of a job to finish an ordered item received from a customer and a name of at least one worker;
a working terminal at which a worker handles a work of a job;
a file server to record a job directory to store at least one file with regard to a job; and
a data base server to record management information to manage a working condition;
wherein when a work start order is inputted by a worker at the working terminal in accordance with the action set by the work setter and the file server connects the working terminal and a job directory to store a job of the action, the file server produces a verification file to record the attribute of the job directory for the worker, and when the worker inputs a work cancel order, the file server produces a comparison file to record the attribute of the job directory for the worker and judges a justification of the work cancel order on a basis of an identity between the attribute of the job directory recorded in the verification file and the attribute of the job directory recorded in the comparison file.

2. The work management system of claim 1, wherein when the action is set by the work setter at the work setting terminal, the data base server records the setting of the action as the management information.

3. The work management system of claim 1, wherein when the work start order with the designation of the action is inputted by the worker at the working terminal and the work terminal requests the file server for a direct connection, the file server inquires the database server to confirm whether this request is justified, and wherein when the request is justified, the file server makes the job directory into a connectable state to permit the work terminal to make the connection and the permitted work terminal directly connects a work directory on the work terminal and the job directory, and then the database server records the fact that work has started, as management information of the action for each worker who uses the work terminal.

4. The work management system of claim 1, wherein when the work cancel order with the designation of the action is inputted at the work terminal, the work terminal requests the file server for cancellation of work, then the file server inquiries the database server to confirm whether this request is justified, and wherein when the request is justified and the work directory on the work terminal and the job directory on the file server are in a state of direct connection, the work terminal disconnects the direct connection between the work directory on the work terminal and the job directory on the server and the database server deletes the management information of the action of each worker who uses the work terminal for the action, and when the request is justified and the work directory on the work terminal and the job directory on the file server are not in a state of connection, the database server deletes the management information of the action of each worker who uses the work terminal for the action.

5. The work management system of claim 1, wherein upon a work suspension order with the designation of an action is inputted at the work terminal, the work terminal disconnects the direct connection between the work directory on the work terminal and the job directory on the file server, and the database server records the fact that the work is suspended.

6. The work management system of claim 1, wherein the managed work includes a group of works.

7. The work management system of claim 1, wherein the file attributes recorded in the verification file and the comparison file do not include file attributes of files that the operation system has automatically created.

8. The work management system of claim 1, wherein the file attributes recorded in the verification file and the comparison file include at least one of a path name, a file name, a file size, an updated date-and-time, and a file type.

9. The work management system of claim 1, wherein when the file server determines that a command to cancel work is justified, the file server deletes a verification file and a comparison file related to the command to cancel work.
